(19) United States
(12) Patent Application Publication
(10) Pub. No.: US 2020/0265067 A1
(43) Pub. Date: Aug. 20, 2020

(54) Method of Synchronizing A Node Database With A Master Database, Device

(71) Applicant: Atos Information Technology GmbH, Munchen (DE)

(72) Inventor: Jan Taschner, Salzkotten (DE)

(73) Assignee: Atos Information Technology GmbH, Munchen (DE)

(21) Appl. No.: 16/793,688

(22) Filed: Feb. 18, 2020

(30) Foreign Application Priority Data
Feb. 18, 2019 (EP) 19157757.6

(51) Int. Cl. G06F 16/27; G06F 16/23; G06F 16/25

(52) U.S. Cl. CPC G06F 16/273; H04W 76/10; G06F 16/258; G06F 16/2365

(57) ABSTRACT

A method of synchronizing a first node database of a first node of a data structure with a master database of a master server includes requesting the master database from the master server, applying a first operating mode when a first connection to the master server is available, and applying a second operating mode when the first connection is not available. The first operating mode includes receiving the master database at least partially, checking the master database for unknown and known objects, checking the known objects for a version, and replacing known objects with an older version in the first node database with objects with a newer version from the master database. The second operating mode includes identifying that the first connection is not available, establishing a second connection to a second node, and synchronizing the first node database with a second node database of the second node.

### CROSS-REFERENCE TO RELATED APPLICATION

This application claims the benefit of the filing date under 35 U.S.C. § 119(a)-(d) of European Patent Application No. 19157757.6, filed on Feb. 18, 2019.

### FIELD OF THE INVENTION

The present invention relates to database synchronization and, more particularly, to synchronizing a node database with a master database.

### BACKGROUND

In distributed systems a master server may act as a central data storage, providing a master database. Client devices in the distributed system, which may be nodes of the distributed system, are required to either access the master database or to access a local, synchronized copy of the master database, particularly a node database. A synchronization between the master database and the node database may occur in regular periods. If a connection to the master server is not available, said synchronization may be temporarily disturbed or temporarily impossible. A client device then has no access to an up-to-date version of the master database, which may cause problems.

State of the art methods of synchronizing data between a node and a master server include relational database management systems (RDBMS), Non Structured Query Language (NoSQL), distributed caches and hash tables or consensus protocols. These methods allow for consistency of the synchronized data.

The data synchronization methods of the state of the art are internet protocol (IP)-based, requiring an IP and a port to establish a transmission control protocol (TCP) connection. The synchronization is only possible as long as the TCP connection is available. There are no means for an alternative communication channel implemented in these methods. Additionally, state of the art methods do not provide mechanisms to select the data for synchronization on single data object level.

### SUMMARY

A method of synchronizing a first node database of a first node of a data structure with a master database of a master server includes requesting the master database from the master server, applying a first operating mode when a first connection to the master server is available, and applying a second operating mode when the first connection is not available. The first operating mode includes receiving the master database at least partially, checking the master database for unknown and known objects, checking the known objects for a version, and replacing known objects with an older version in the first node database with objects with a newer version from the master database. The second operating mode includes identifying that the first connection is not available, establishing a second connection to a second node, and synchronizing the first node database with a second node database of the second node.

### BRIEF DESCRIPTION OF THE DRAWINGS

The invention will now be described by way of example with reference to the accompanying Figures, of which:

FIG. 1 is a block diagram of a data structure according to an embodiment;

FIG. 2 is a flowchart of a method of database synchronization in the data structure;

FIG. 3 is a block diagram of a master database and a first node database of the data structure during synchronization;

FIG. 4 is a block diagram of a data structure according to another embodiment;

FIG. 5 is a flowchart of a node synchronizing step according to an embodiment;

FIG. 6 is a block diagram of a data structure according to another embodiment; and

FIG. 7 is a block diagram of a mobile device according to an embodiment.

### DETAILED DESCRIPTION OF THE EMBODIMENT(S)

The properties, features and advantages of the present invention as well as the way in which they are achieved, will become more clearly and comprehensively understandable in connection with the following description of the exemplary embodiments, which will be explained in more detail in connection with the drawings.

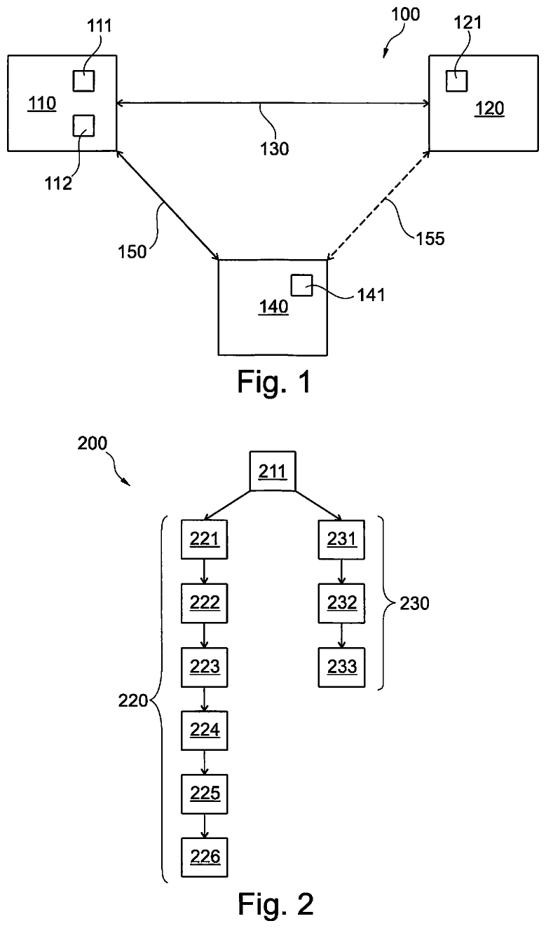

FIG. 1 shows a data structure 100 in which a method according to the invention may be executed. A first node 110 comprises a first node database 111 and an optional storage medium 112. The first node 110 is connected to a master server 120 with a first connection 130. The master server 120 comprises a master database 121.

A second node 140 with a second node database 141 is connected to the first node 110 with a second connection 150. The second node 140 may be connected to the master server 120 with an optional third connection 155. To illustrate that the third connection 155 is optional, the third connection 155 is displayed with a dashed line in FIG. 1, whereas the first connection 130 and the second connection 150 are displayed with a continuous line. The master server 120 may have additional connections not shown in FIG. 1, particularly to more nodes and/or to additional servers providing data and/or server based applications.

FIG. 2 shows a flow diagram of a method 200 according to the invention, which may be executed in the data structure 100 of FIG. 1. The method 200 can be used to synchronize the first node database 111 of the first node 110 of the data structure 100 with the master database 121 of the master server 120. The method 200 comprises a first operating mode 220 and a second operating mode 230. The first operating mode 220 is applied when the first connection 130 of the first node 110 to the master server 120 is available. The second operating mode 230 is applied when the first connection 130 is not available.

In an initial request step 211, shown in FIG. 2, the master database 121 is requested from the master server 120.

If the request step 211 leads to a transfer of the requested master database 121 or to an answer to the request from the master server 120, the first operating mode 220 is applied. In the first operating mode 220, a first receiving step 221 is carried out, in which the master database 121 is at least partially received. Subsequently, a first checking step 222 is carried out, in which the master database 121 is checked for unknown and known objects. Particularly, in the first checking step 222 it is evaluated for every object within the master database 121 received in the first receiving step 221 if said object is already part of the first node database 111. If the object is already part of the first node database 111, said object is classified as a known object. If the object is not part of the first node database 111, said object is classified as an unknown object.

Subsequently, a second checking step 224 is carried out, as shown in FIG. 2, in which the known objects are checked for a version. In a first replacing step 225 the known objects with older version in the first node database 111 are replaced with the known objects with newer version from the master database 121. Therefore, in the first operating mode 220, a synchronization of the master database 121 and the first node database 111 takes place, leading to an up-to-date first node database 111 available for the first node 110.

If the request step 211 does not lead to a transfer of the requested master database 121 or to an answer to the request from the master server 120, the second operating mode 230 shown in FIG. 2 is applied. In the second operating mode 230, an identifying step 231 is carried out in which it is identified that the first connection 130 is not available. In a connecting step 232, the second connection 150 to the second node 140 is established. Subsequently, in a node synchronizing step 233 the second node database 141 is synchronized with the first node database 111.

The second node 140 either may be connected to the master server 120 or may have lost its communication channel to the master server 120 as well. In the first case, the second node database 141 is synchronized with the master database 121, and therefore, the first node database 111 is also up-to-date after the node synchronization step 233. In the second case, the first node database 111 may not be up-to-date with the master database 121, but updated using data from the second node database 141 and therefore more up-to-date than initially. The method thusly allows for an additional communication channel if the communication channel to the master server 120 is lost.

An optional first adding step 223 is shown in FIG. 2 between the first checking step 222 and the second checking step 224. In the first adding step 223, at least one unknown object, particularly all unknown objects identified during the first checking step 222 is/are added to the first node database 111. The first adding step 223 may be carried out after the second checking step 224 or the first replacing step 225 as well.

In one embodiment, an additional first sending step 226 shown in FIG. 2 is carried out. In the first sending step 226, objects with newer versions within the first node database 111 and/or objects, which are part of the first node database 111, but not part of the master database 121 are sent to the master database 121. Therefore, the master database 121 may be updated, leading to a more up-to-date master database 121.

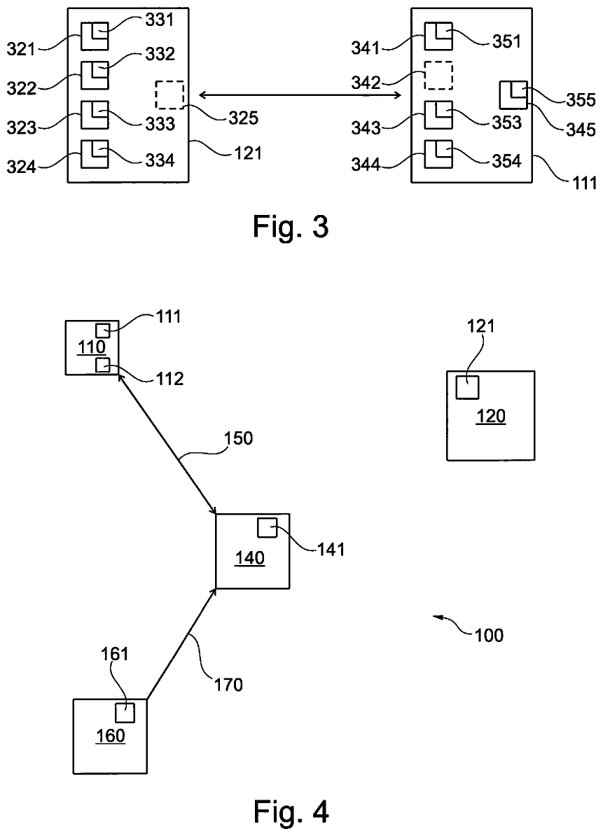

FIG. 3 shows the master database 121 and the first node database 111 during the first operating mode 220. The master database 121 comprises a first master object 321, a second master object 322, a third master object 323, and a fourth master object 324. A first master version 331 is assigned to the first master object 321. A second master version 332 is assigned to the second master object 322. A third master version 333 is assigned to the third master object 323. A fourth master version 334 is assigned to the fourth master object 324. The first node database 111 comprises a first node object 341, a third node object 343, a fourth node object 344, and a fifth node object 345. A first node version 351 is assigned to the first node object 341. A third master version 353 is assigned to the third node object 343. A fourth node version 354 is assigned to the fourth node object 344. A fifth node version 355 is assigned to the fifth node object 345.

During the first checking step 222 it is possible to identify the second master object 322 as unknown object as no second node object exists. Therefore, in the first adding step 223 the second master object 322 is added to the first node database 111 forming a second node object 342. To emphasize the fact that the second node object 342 is added to the first node database 111, the second node object 342 is displayed with a dashed line in FIG. 3. The remaining master objects 321, 323, 324 are known objects, as corresponding node objects 341, 343, 344 exist. For these objects the master versions 331, 333, 334 are compared to the corresponding node versions 351, 353, 354 in the second checking step 224. If any master version 331, 333, 334 is newer than the corresponding node version 351, 353, 354, the corresponding node object 341, 343, 344 is replaced with the corresponding master object 321, 323, 324 in the first replacing step 225. If for instance the third master version 333 is newer than the third node version 353, the third node object 343 is replaced with the third master object 323.

In the optional first sending step 226, the fifth node object 345 is sent to the master database 121, subsequently forming a fifth master object 325. To emphasize the fact that the fifth master object 325 is added to the master database 121, the fifth master object 325 is displayed with a dashed line in FIG. 3. If any master version 331, 333, 334 is older than the corresponding node version 351, 353, 354, the corresponding node object 341, 343, 344 may be sent to the master database 121 in the optional first sending step 226 additionally or alternatively. If, for instance, the fourth master version 334 is older than the fourth node version 354, the fourth node object 344 is sent to the master database 121.

The methods explained for the synchronization of the master database 121 and the first node database 111 with regard to FIG. 3 may also be used during the synchronization of the first node database 111 with the second node database 141 during the node synchronization step 233.

In an embodiment, the first connection 130 shown in FIG. 1 is established as a broad bandwidth connection, particularly as an internet connection, a Wireless-Local Area Network (LAN) or a LAN connection. Therefore, in the first operating mode 220, the whole master database 121 may be received by the first node 110, as the bandwidth of the first connection 130 does not confine the data volume to be transferred. Alternatively, only a part of the master database 121 may be received due to a pre-selection of data. In this case, the data volume to be transferred may be reduced.

In an embodiment, the second connection 150 is established as a low bandwidth connection, particularly as peer-to-peer connection, a Bluetooth connection, an infrared connection, an ad-hoc wireless LAN connection and/or a near-field communication. Using this approach, it may be necessary to implement a pre-selection of data transferred during the node synchronization step 233 to reduce the data volume to be transferred.

In one embodiment, the objects of the master database 121, for instance the master objects 321, 322, 323, 324, 325 and/or the objects in the node database 111, particularly the node objects 341, 342, 343, 344, 345 comprise selection criteria. During the first receiving step 221 and/or during the node synchronization step 233, objects are selected according to the selection criteria. The selection criteria may include time and/or location. Thusly, the selection criteria allow for a selection of objects to be synchronized and/or transferred, reducing the data volume to be transferred, as the data transferred during the first receiving step 221 and/or during the node synchronization step 233 may be pre-selected and only objects to be included into the first node database 111 are transmitted and therefore received by the first node 110.

The databases (master database 121, node databases 111, 141) can include an information file stating an information about content of the objects and a version of the objects within the databases. The content information may include the type of objects. By comparing the versions, the objects to be transferred may be selected. Alternatively or additionally, the selection criteria may be used to select the objects to be transferred.

FIG. 4 shows a data structure 100 according to another embodiment; only the differences with respect to the data structure 100 of the embodiment of FIG. 1 will be described in detail herein.

As shown in FIG. 4, the second node 140 is connected to a third node 160 with a fourth connection 170. The third node 160 comprises a third node database 161. The third node database 161 is synchronized with the second node database 141. Therefore, during the synchronization of the second node database 141 with the first node database 111, the first node database 111 is also synchronized to the third node database 161. The nodes 110, 140, 160 are not connected to the master server 120 in FIG. 4. This might be due to a loss of internet connectivity or due to other technical problems. In this case, the first node 110 switches into the second operating mode 230. The second node 140 and the third node 160 may switch to the second operating mode 230 as well. The node databases 111, 141, 161 are then synchronized to provide the most actual available data for each node 110, 140, 160. The synchronization between the second node database 141 and the third node database 161 may be similar to the synchronization between the first node database 111 and the second node database 141 during the node synchronization step 233 shown in FIG. 2 and described above.

In one embodiment, the first node 110 in the embodiment of FIG. 4 attempts to establish a reconnection to the master server 120 via the first connection 130 shown in FIG. 1 after a pre-defined timespan has expired. Additionally or alternatively, the second node 140 and/or the third node 160 may also try to establish a renewed connection to the master server 120.

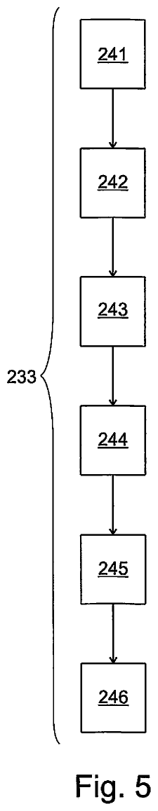

FIG. 5 shows a flow diagram of an embodiment of the node synchronization step 233. In the node synchronization step 223, a second receiving step 241 is carried out, in which the second node database 141 is at least partially received. Subsequently, a third checking step 242 is carried out, in which the second node database 141 is checked for unknown and known objects. Particularly, in the third checking step 242 it is evaluated for every object within the second node database 141 received in the second receiving step 241 if said object is already part of the first node database 111. If the object is already part of the first node database 111, said object is classified as a known object. If the object is not part of the first node database 111, said object is classified as an unknown object.

In a subsequent, optional second adding step 243 shown in FIG. 5, at least one of the unknown objects identified during the third checking step 242, particularly all unknown objects identified during the third checking step 242 is/are added to the first node database 111. Additionally, a fourth checking step 244 is carried out, in which the known objects are checked for a version. The version of the objects may be identified using a timestamp or a version number. Particularly, the version may be identified using a Lamport-timestamp. In a second replacing step 245, the known objects with older version in the first node database 111 are replaced with the known objects with newer version from the second node database 141. The second adding step 243 may be carried out after the fourth checking step 244 or the second replacing step 245 as well.

In one embodiment, an additional second sending step 246 shown in FIG. 5 is carried out. In the second sending step 246, objects with newer versions within the first node database 111 and/or objects, which are part of the first node database 111, but not part of the second node database 141 are sent to the second node database 141.

In one embodiment, the first node database 111, the second node database 141 and the master database 121 are transformed using a data-interchange format. This format may be used as a universal, language-independent data format. Particularly, the data format of the databases 111, 121, 141 may be different. By serializing the databases 111, 121, 141 into a data-interchange format, a universal data format is provided. Each node 110, 140 and the master server 120 then do not need to know the data format for the other database, but only how to serialize and deserialize its own data format of the database to a data-interchange format. The data-interchange format may, for example, be JacaScript Object Notation (JSON), Binary JSON (B SON), YAML Ain't Markup Language (YAML) or any other applicable data-interchange format.

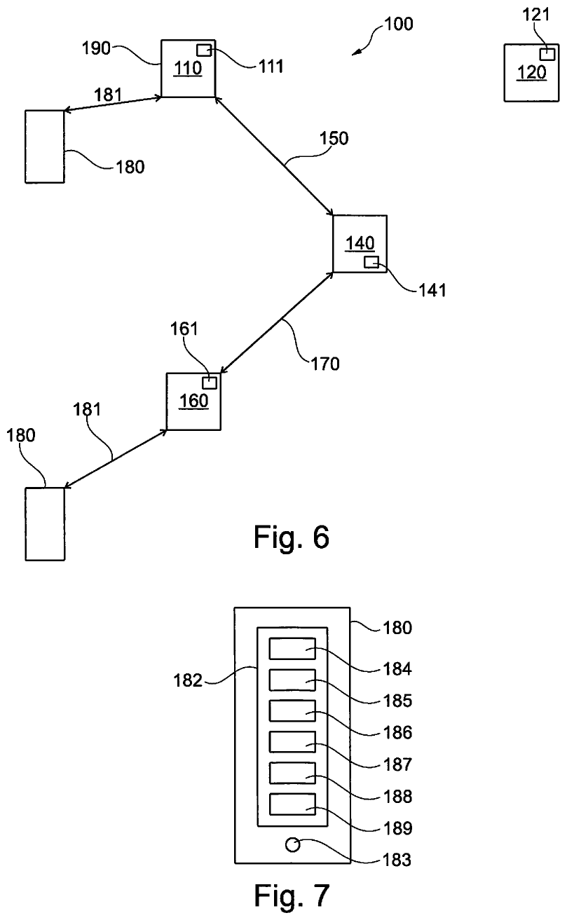

FIG. 6 shows a data structure 100 according to another embodiment; only the differences with respect to the data structure 100 of the embodiment of FIG. 4 will be described in detail herein.

As shown in FIG. 6, the first node 110 is assigned to a device 190. The device 190 comprises means to carry out the method 200. The data structure 100 further comprises two mobile devices 180. One mobile device 180 is connected to the first node 110 with a device connection 181. The other mobile device 180 is connected to the third node 160 with a device connection 181. The mobile devices 180 may use the corresponding device connections 181 to access the first node database 111 and the third node database 161 respectively. In this case, the first node 110, the second node 140 and/or the third node 160 may be edge devices organizing the synchronization of the node databases 111, 141, 161 and the synchronization of the node databases 111, 141, 161 with the master database 121 if a connection to the master server 120 is available. Applications running on the mobile devices 180 may use the data provided by the node databases 111, 141, 161.

Alternatively to the embodiment in shown in FIG. 6, the mobile devices 180 may act as additional nodes within the data structure 100 and also comprise a node database. In this case, one of the mobile devices 180 may also act as the first node 110 within the method 200 and additionally establish the first connection 130 to the master server 120.

In an embodiment, the first node database 111 comprises information about outstanding and/or completed tasks. These tasks may be tasks to be performed during emergency management. Personnel deployed to a catastrophe site may need to perform certain tasks to reduce effects of a catastrophe. This personnel may be equipped with a mobile device 180, acting as first node 110 or connected to the first node 110, which in this case may be an edge device. The mobile device 180 may display the tasks to be performed. The master database 121 comprises the tasks and the information if these tasks are still outstanding or already completed. If the first connection 130 is interrupted, particularly due to the catastrophe having effects on communication networks, the mobile devices 180 and therefore the nodes 110, 140, 160 may switch to the second operating mode 230 allowing for an additional local synchronization of the node databases 111, 141, 161 to improve information about the tasks for all nodes 110, 140, 160. In this case, selection criteria such as location and/or time may be useful to reduce the bandwidth needed for the node synchronization via low bandwidth connections, as only tasks within a certain radius need to be finished to reduce the effects of the catastrophe. Tasks assigned to different locations therefore do not need to be synchronized and therefore bandwidth during the synchronization in the second operating mode 230 may be saved. Additionally or alternatively, only the execution of tasks created after the occurrence of the catastrophe may be needed. Therefore, tasks with a preceding creating time may be excluded from the database synchronization to further save bandwidth. It is possible for the deployed personnel to bring the nodes 110, 140, 160 with them. It is also possible to select objects in the vicinity of the first node 110, particularly within a pre-defined radius, if the first operation mode 220 is applied.

FIG. 7 shows a mobile device 180 with a display 182 and an input unit 183. On the display 182, a first task 184, a second task 185, a third task 186, a fourth task 187, a fifth task 188 and a sixth task 189 are displayed. A human using the mobile device 180 may select one of the tasks 184, 185, 186, 187, 188, 189 and confirm to execute said task. The mobile device 180 then sends this information to a node 110, 140, 160 within the data structure 100 via the device connection 181 or is configured as node 110, 140, 160. Subsequently the status information about the task selected to be executed may be synchronized using the method described above.

The invention further includes a computer program comprising a sequence of computer-executable instructions stored on a non-transitory computer readable medium which, when executed by a computer, cause the computer to carry out the method 200.

The invention further includes a device for carrying out the method 200, the device particularly acting as the first node 110 of the method 200. The device may comprise a non-transitory computer-readable storage medium 112, and the computer program may be stored within the storage medium 112. In FIG. 1 such a storage medium 112 is displayed. The device 180 may be a handheld device like a mobile phone or a tablet PC. Alternatively, the device 180 may be a single board computer. The single board computer may be an edge device organizing the synchronization of the node databases of mobile devices.

The invention has been illustrated and described in detail with respect to exemplary embodiments. The invention is nevertheless not restricted to those examples disclosed. Rather, other variants may be derived therefrom by the person skilled in the art without departing from the protective scope of the invention.

The present invention allows for a synchronization method including a more robust synchronization of a node database 111 with a master database 121, leading to less problems should a connection to the master server 120 not be available. The invention also allows the selection of data for synchronization on data object level.

What is claimed is:

1. A method of synchronizing a first node database of a first node of a data structure with a master database of a master server, comprising:
requesting the master database from the master server in a request step;
applying a first operating mode when a first connection to the master server is available, the first operating mode including the steps of:
receiving the master database at least partially in a first receiving step;
checking the master database for unknown and known objects in a first checking step;
checking the known objects for a version in a second checking step; and
replacing known objects with an older version in the first node database with objects with a newer version from the master database in a first replacing step; and
applying a second operating mode when the first connection to the master server is not available, the second operating mode including the steps of:
identifying that the first connection is not available in a identifying step;
establishing a second connection to a second node in a connecting step; and
synchronizing the first node database with a second node database of the second node in a node synchronization step.

2. The method of claim 1, wherein, in the first operating mode, at least one unknown object is added to the first node database in a first adding step.

3. The method of claim 1, wherein, in the first operating mode, objects with a newer version in the first node database are sent to the master server.

4. The method of claim 1, wherein the first connection is a broad bandwidth connection, and is an internet connection, a wireless-LAN, or a LAN connection.

5. The method of claim 1, wherein the second connection is a low bandwidth connection, and is a peer-to-peer connection, a Bluetooth connection, an infrared connection, an ad-hoc wireless LAN connection and/or a near-field communication.

6. The method of claim 1, wherein a plurality of objects in the master database, the first node database, and/or the second node database each have a selection criteria, the objects are selected during the first receiving step and/or during the node synchronization step according to the selection criteria.

7. The method of claim 6, wherein the selection criteria include time and/or location.

8. The method of claim 1, wherein, in the second operating mode, objects with a newer version in the first node database are sent to the second node.

9. The method of claim 1, wherein, after a pre-defined timespan during which the second operating mode is executed, reconnection to the master server is attempted via the first connection.

10. The method of claim 1, wherein the first node database, the second node database, and the master database are transformed using a data-interchange format.

11. The method of claim 1, wherein the node synchronization step includes:
receiving the second node database at least partially in a second receiving step;
checking the second node database for unknown and known objects in a third checking step;
checking the known objects for a version in a fourth checking step; and
replacing known objects with the older version in the first node database with objects with a newer version from the second node database in a second replacing step.

12. The method of claim 1, wherein the first node database and/or the master database include information about outstanding and/or completed tasks.

13. The method of claim 1, wherein the first operating mode is applied if the request step leads to a transfer of the master database or to an answer to the request from the master server, and the second operating mode is applied if the request step does not lead to the transfer of the master database or to the answer to the request from the master server.

14. A computer program including a sequence of computer-executable instructions which, when executed by a computer, cause the computer to carry out the method according to claim 1.

15. A device for carrying out the method according to claim 1, the device acting as the first node.

16. The device of claim 15, further comprising a non-transitory computer-readable storage medium, a computer program including a sequence of computer-executable instructions which, when executed by a computer, cause the computer to carry out the method according to claim 1 is stored in the non-transitory computer-readable storage medium.

17. A method of synchronizing a first node database of a first node of a data structure with a master database of a master server, comprising:
requesting the master database from the master server in a request step;
applying a first operating mode when a first connection to the master server is available, the first connection is a broad bandwidth connection and is an internet connection, a wireless-LAN, or a LAN connection, the first operating mode including the steps of:
receiving the master database at least partially in a first receiving step;
checking the master database for unknown and known objects in a first checking step;
checking the known objects for a version in a second checking step; and
replacing known objects with an older version in the first node database with objects with a newer version from the master database in a first replacing step; and
applying a second operating mode when the first connection to the master server is not available, the second operating mode including the steps of:
identifying that the first connection is not available in a identifying step;
establishing a second connection to a second node in a connecting step, the second connection is a low bandwidth connection and is a peer-to-peer connection, a Bluetooth connection, an infrared connection, an ad-hoc wireless LAN connection and/or a near-field communication; and
synchronizing the first node database with a second node database of the second node in a node synchronization step.

18. The method of claim 17, wherein the first operating mode is applied if the request step leads to a transfer of the master database or to an answer to the request from the master server, and the second operating mode is applied if the request step does not lead to the transfer of the master database or to the answer to the request from the master server.
